(19) United States
(12) Patent Application Publication
(10) Pub. No.: US 2015/0191860 A1
(43) Pub. Date: Jul. 9, 2015

(54) DAMPER AND WASHING MACHINE INCLUDING THE SAME

(71) Applicant: SAMSUNG ELECTRONICS CO., LTD., Suwon-si (KR)

(72) Inventors: Kyung Sub SIM, Seoul (KR); Sun Yong KIM, Suwon-si (KR)

(73) Assignee: SAMSUNG ELECTRONICS CO., LTD., Suwon-si (KR)

(21) Appl. No.: 14/488,920

(22) Filed: Sep. 17, 2014

(30) Foreign Application Priority Data
Jan. 6, 2014 (KR) 10-2014-0001520

(51) Int. Cl. D06F 37/26; F16F 1/04

(52) U.S. Cl. CPC D06F 37/265; F16F 1/04

(57) ABSTRACT

A damper having an improved structure in which a constant damping force can be maintained, and a washing machine including the same. The washing machine includes a damper provided in a cabinet so as to dampen vibration of a tub, wherein the damper includes: a suspension rod having one end coupled to the cabinet; a movement member that is coupled to an outer side of the suspension rod so as to move along the suspension rod integrally with the tub; a support member that is coupled to the other end of the suspension rod; and a shock-absorbing member provided between the movement member and the support member so as to vary due to vibration transmitted from the tub, and wherein at least one lubricant accommodation portion is formed at an inner side of the movement member so as to accommodate a lubricant applied to the suspension rod.

### CROSS-REFERENCE TO RELATED APPLICATIONS

This application claims the priority benefit of Korean Patent Application No. 10-2014-0001520, filed on Jan. 6, 2014, in the Korean Intellectual Property Office, the disclosure of which is incorporated herein by reference.

### BACKGROUND

1. Field

Example embodiments of the present disclosure relate to a damper and a washing machine including the same, and more particularly, to a damper having an improved structure in which a constant damping force can be maintained for long periods of time, and a washing machine including the same.

2. Description of the Related Art

In general, a washing machine is a machine that washes laundry by performing washing, rinsing, and dehydration operations.

A washing machine that is classified as a pulsator type is a washing machine that washes laundry due to a shock applied to the laundry caused by a water current generated when a rotating wing, having small wings, and which is placed at a lower portion of a washing tub, is rotated. Further, an agitator type washing machine washes laundry by forming a water current when a direction of a large agitating wing, having wings, that is placed in the center of the washing tub, is regularly reversed. Additionally, a drum type washing machine washes laundry with shock caused by a fall and a washing force of a detergent by putting the laundry in a drum and rotating the drum.

A washing machine may include a cabinet, a tub installed in the cabinet and in which washing water is accommodated, a washing tub rotatably installed at the tub and in which laundry is accommodated, a driving unit that rotates the washing tub, a water supply unit that supplies washing water to the tub, and a draining unit that discharges washing water toward an outer side of the cabinet from the washing tub if washing is finished.

When the washing tub is rotated by the driving unit, the tub is moved in the cabinet. Vibration that occurs in this case is shock-absorbed by a damper.

That is, the damper reduces vibration and noise that occur during washing.

A lubricant may be used to improve performance and durability of the damper. However, the lubricant stored in a lubricant pocket placed at an upper portion of the damper may be discharged to the outside from the lubricant pocket due to the tub that moves in a vertical direction during a washing or dehydration operation. As a result, a noise- or vibration-damping force of the damper may be reduced.

### SUMMARY

Therefore, it is an aspect of the present disclosure to provide a damper having an improved structure in which the occurrence of a phenomenon that a lubricant is discharged to the outside can be prevented, and a washing machine including the damper.

It is another aspect of the present disclosure to provide a damper having an improved structure in which a constant damping force can be maintained, and a washing machine including the damper.

It is still another aspect of the present disclosure to provide a damper having an improved structure in which durability can be improved, and a washing machine including the damper.

Additional aspects of the present disclosure will be set forth in part in the description which follows and, in part, will be obvious from the description, or may be learned by practice of the invention.

In accordance with one aspect of the present disclosure, a washing machine may include a damper provided in a cabinet so as to dampen vibration of a tub, wherein the damper may include: a suspension rod having one end coupled to the cabinet; a movement member that is coupled to an outer side of the suspension rod so as to move along the suspension rod integrally with the tub; a support member that is coupled to the other end of the suspension rod; and a shock-absorbing member provided between the movement member and the support member so as to vary due to vibration transmitted from the tub, and wherein at least one lubricant accommodation portion may be formed at an inner side of the movement member so as to accommodate a lubricant applied to the suspension rod.

The at least one lubricant accommodation portion may be recessed toward an outer side of the movement member so as to be far apart from the suspension rod.

The at least one lubricant accommodation portion may be spaced apart from each other by a predetermined distance.

A penetration portion to which the suspension rod is movably coupled and which has different widths, may be formed in the movement member.

The penetration portion may include: a first pipe in which the at least one lubricant accommodation portion is formed; and a second pipe that is connected to the first pipe and protrudes toward an outer side of the first pipe.

The damper may further include a frictional member placed between the suspension rod and the second pipe.

One end of the at least one lubricant accommodation portion may be opened toward the frictional member so that the lubricant can be transmitted to the frictional member.

The at least one lubricant accommodation portion may be recessed toward the outer side of the movement member by a degree in which the second pipe protrudes toward the outer side of the first pipe.

A penetration hole to which the suspension rod is coupled, may be formed in one end of the first pipe, and the at least one lubricant accommodation portion may be formed around the first pipe so as to be spaced apart from the through hole by a predetermined gap toward the second pipe.

In another example embodiment, the at least one lubricant accommodation portion may have a shape of a hemisphere that is recessed toward an outer side of the movement member.

Further, the at least one lubricant accommodation portion that accommodates the lubricant may be formed at an inner side of the movement member so as to be spaced apart from both ends of the movement member by a predetermined gap, thereby preventing the lubricant from being discharged to an outer side of the at least one lubricant accommodation portion due to vibration of the tub.

In accordance with another aspect of the present disclosure, a washing machine includes a damper provided in a cabinet so as to dampen vibration of a tub, wherein the damper may include: a suspension rod having a top end coupled to the cabinet; a movement member which is coupled to an outer side of the suspension rod so as to move along the suspension rod integrally with the tub and in which at least one lubricant accommodation portion is provided to accommodate a lubricant applied to the suspension rod; and a shock-absorbing member that is provided between the movement member and a bottom end of the suspension rod so as to be relaxed or contracted due to vibration transmitted from the tub, wherein the at least one lubricant accommodation portion may be formed at an inner side of the movement member so as to be spaced apart from both ends of the movement member by a predetermined gap.

A penetration portion to which the suspension rod is movably coupled and which has different widths, may be formed in the movement member.

A penetration hole to which the suspension rod is coupled, may be formed in a top end of the penetration portion, and the at least one lubricant accommodation portion may be placed below the penetration hole so as to be spaced apart from the penetration hole by a predetermined gap.

The penetration portion may include: a first pipe having a top end in which the penetration hole is formed, the at least one lubricant accommodation portion being formed below the penetration hole; and a second pipe that is connected to a bottom end of the first pipe and protrudes toward an outer side of the first pipe.

The at least one lubricant accommodation portion may be recessed toward an outer side of the first pipe by a degree in which the second pipe protrudes toward the outer side of the first pipe.

The damper may further include a frictional member placed between the suspension rod and the second pipe, and one end of the at least one lubricant accommodation portion may be opened toward the frictional member so that the lubricant can be transmitted to the frictional member.

In accordance with still another aspect of the present disclosure, a damper may include: a suspension rod; a movement member which is coupled to an outer side of the suspension rod so as to move along the suspension rod and in which at least one lubricant accommodation portion is formed to accommodate a lubricant applied to the suspension rod; a support member fixed to the suspension rod so as to be spaced apart from the movement member by a predetermined gap; and a shock-absorbing member having one end connected to the movement member so that a length of the shock-absorbing member varies according to movement of the movement member and the other end connected to the support member, wherein the at least one lubricant accommodation portion may be formed at an inner side of the movement member so as to be spaced apart from both ends of the movement member by a predetermined gap and to prevent the lubricant from being discharged to the outside.

The at least one lubricant accommodation portion may be recessed toward an outer side of the movement member.

Degrees in which the at least one lubricant accommodation portion is recessed, may be diverse.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view of a washing machine according to an example embodiment of the present disclosure;

FIG. 2 is an enlarged cross-sectional view of part of the washing machine illustrated in FIG. 1;

FIG. 3 is a cross-sectional view illustrating a damper of a washing machine according to an example embodiment of the present disclosure;

FIG. 4 is an enlarged view of a movement member that constitutes the damper illustrated in FIG. 3;

FIG. 5 is a bottom view illustrating part of the damper of FIG. 4; and

FIG. 6 illustrates a movement member that constitutes a damper of a washing machine according to another example embodiment of the present disclosure.

### DETAILED DESCRIPTION

Reference will now be made in detail to the embodiments of the present invention, examples of which are illustrated in the accompanying drawings, wherein like reference numerals refer to like elements throughout.

The terms used herein, such as a “front end”, a “rear end”, an “upper portion”, a “lower portion”, a “top end”, and a “bottom end”, are defined based on the drawings, and the shape and position of each element are not limited by the terms.

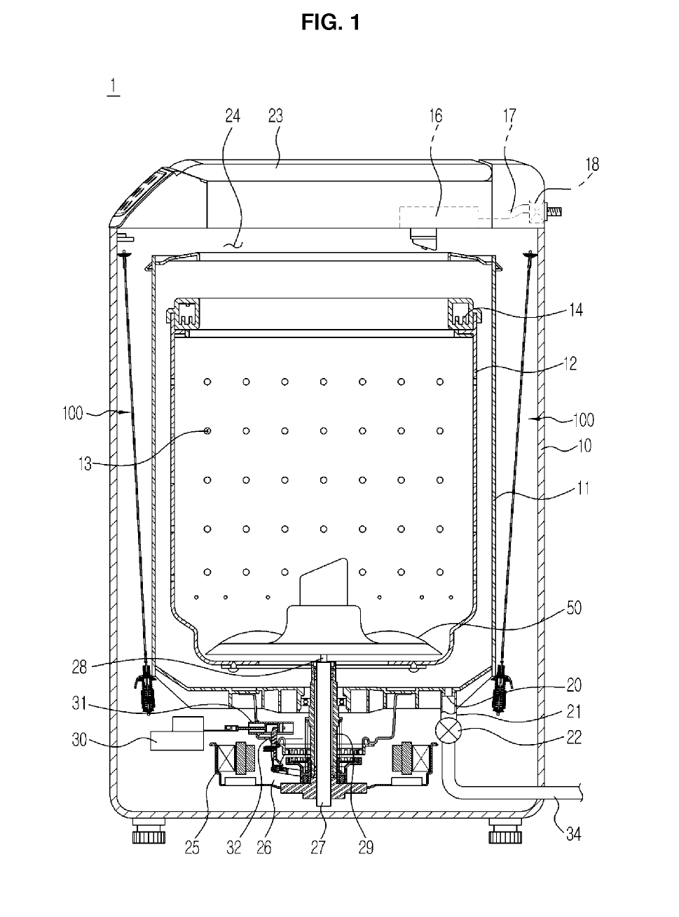

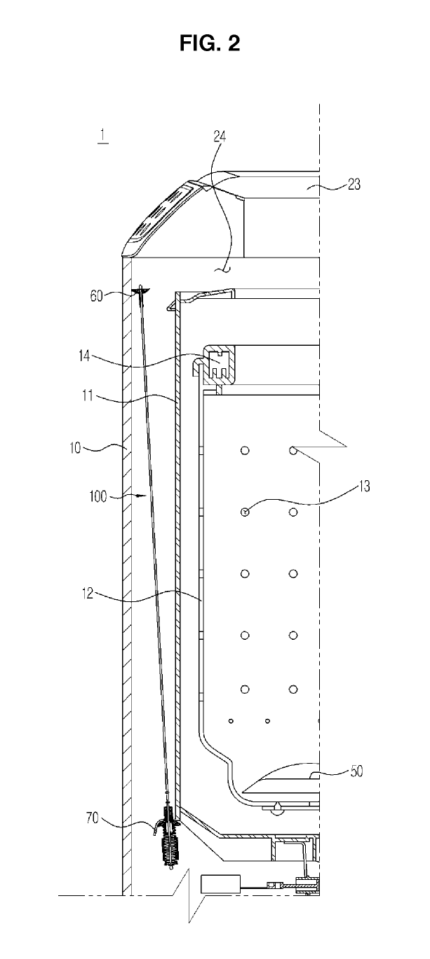

FIG. 1 is a cross-sectional view of a washing machine according to an example embodiment of the present disclosure, and FIG. 2 is an enlarged cross-sectional view of part of the washing machine illustrated in FIG. 1.

As illustrated in FIGS. 1 and 2, a washing machine 1 may include a cabinet 10 that constitutes an exterior, a tub 11 which is disposed in the cabinet 10 and in which washing water is stored, a washing tub 12 that is rotatably disposed in the tub 11, and a pulsator 50 that is disposed in the washing tub 12 and generates a water current.

A laundry port 24 through which laundry may be placed into the washing tub 12, is formed at an upper portion of the cabinet 10. The laundry port 24 may be opened/closed by a door 23 installed at the upper portion of the cabinet 10. The tub 11 may be supported on the cabinet 10 by a damper 100.

A water supply pipe 17 may be installed at an upper portion of the tub 11 so as to supply washing water to the tub 11. One side of the water supply pipe 17 is connected to an external water supply source, and the other side of the water supply pipe 17 is connected to a detergent supply unit 16. Water supplied through the water supply pipe 17 is supplied into the tub 11 together with detergent via the detergent supply unit 16. A water supply valve 18 may be installed at the water supply pipe 17 so as to control the supply of water.

The washing tub 12 may have a cylindrical shape in which an upper portion of the washing tub 12 is opened, and a plurality of dehydration holes 13 may be formed along the sides of the washing tub 12, as shown in FIG. 1. A balancer 14 may be mounted on the upper portion of the washing tub 12 so that the washing tub 12 can be stably rotated when the washing tub 12 is rotated at high speed.

A motor 25 that generates a driving force for rotating the washing tub 12 and the pulsator 50, and a power transmission unit 26 that transmits the driving force generated by the motor 25 to the washing tub 12 and the pulsator 50 simultaneously or selectively, may be installed at an outer side of a lower side of the tub 11.

A hollow type dehydration shaft 29 may be coupled to the washing tub 12, and a washing shaft 27 installed at a hollow portion of the dehydration shaft 29 may be coupled to the pulsator 50 through a washing shaft coupling portion 28. The motor 25 may transmit the driving force to the washing tub 12 and the pulsator 50 simultaneously or selectively according to an ascending/descending operation of the power transmission unit 26.

The power transmission unit 26 may include an actuator 30 that generates a driving force for power transmission, a load portion 31 that makes a rectilinear motion according to an operation of the actuator 30, and a clutch portion 32 that is connected to the load portion 31 and pivots according to an operation of the load portion 31.

A drainage hole 20 through which washing water stored in the tub 11 can be discharged, is formed in the bottom of the tub 11, and a first drainage pipe 21 is connected to the drainage hole 20. A drainage valve 22 may be installed at the first drainage pipe 21 so as to restrain drainage. An outlet of the drainage valve 22 may be connected to a second drainage pipe 34 for discharging washing water to the outside.

The damper 100 may be provided in the cabinet 10 so as to dampen vibration of the tub 11. In detail, the damper 100 may be coupled to a first holder 60 formed at an upper side of an inner surface of the cabinet 10 and a second holder 70 formed at a lower side of an outer surface of the tub 11 so as to alleviate vibration and shock transmitted from the tub 11. The positions of the first holder 60 and the second holder 70 shown in FIG. 2 are exemplary, and thus, the present disclosure is not limited thereto. For example, the positions of the first holder 60 and the second holder 70 may be changed.

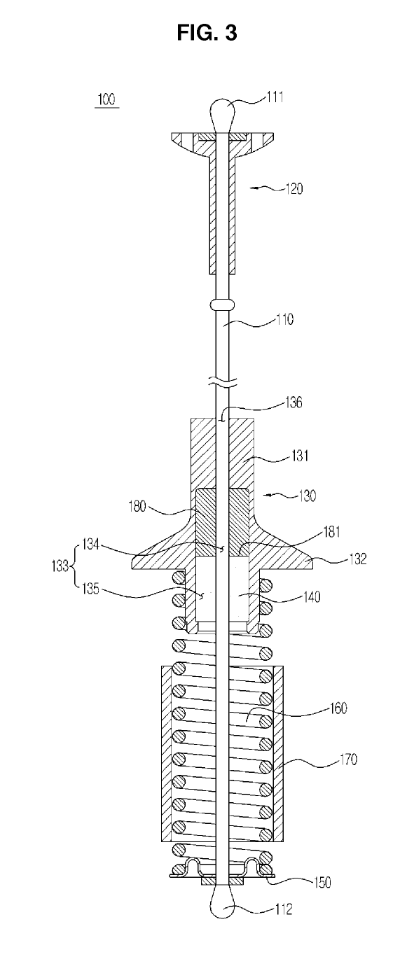

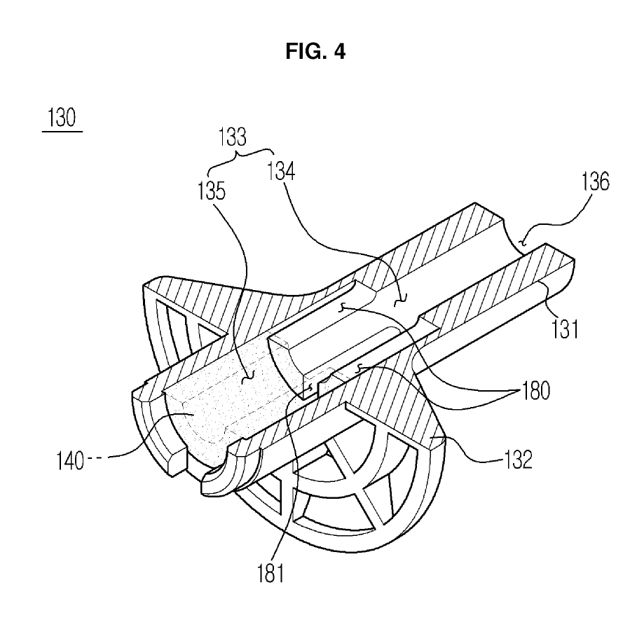

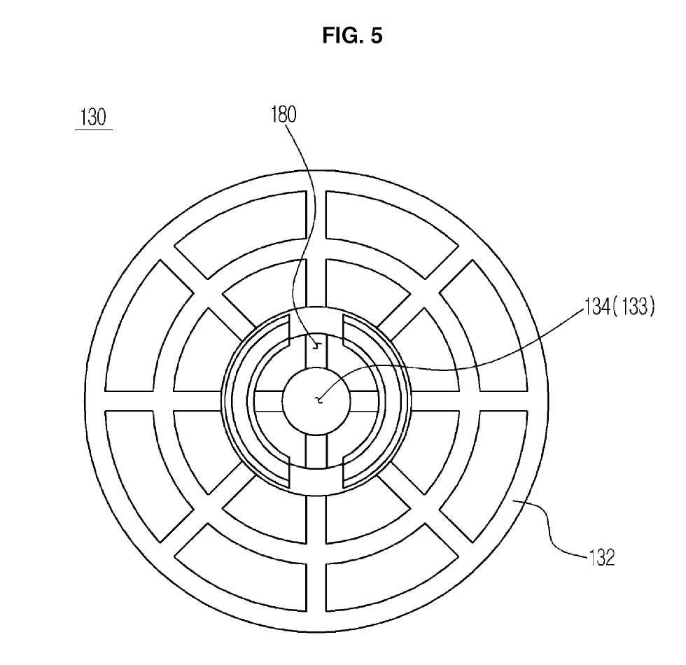

FIG. 3 is a cross-sectional view illustrating a damper of a washing machine according to an example embodiment of the present disclosure. FIG. 4 is an enlarged view of a movement member that constitutes the damper illustrated in FIG. 3. FIG. 5 is a bottom view illustrating part of the damper of FIG. 4. Unillustrated reference numerals refer to FIGS. 1 and 2.

As illustrated in FIGS. 3 through 5, the damper 100 may include a suspension rod 110.

A first fixing portion 111 may be formed at a top end of the suspension rod 110, and a second fixing portion 112 may be formed at a bottom end of the suspension rod 110.

The damper 100 may further include a fixing member 120.

The fixing member 120 may be coupled to an outer side of the suspension rod 110 so as to prevent the fixing member 120 from being separated from the suspension rod 110 by the first fixing portion 111. The fixing member 120 may be coupled to and fixed to the first holder 60 formed at the cabinet 10. Further, the shape of the fixing member 120 as shown in FIG. 3 is exemplary, and thus, the present disclosure is not limited thereto.

The damper 100 may further include a movement member 130.

The movement member 130 may be coupled to the outer side of the suspension rod 110 so as to move along the suspension rod 110. The movement member 130 may be coupled to the second holder 70 formed at the tub 11 and may move integrally with the tub 11.

The movement member 130 may include a body 131 and a hanging portion 132.

In detail, the body 131 may constitute an exterior of the movement member 130, and a penetration portion 133 to which the suspension rod 110 is movably coupled, may be formed in the body 131. The hanging portion 132 may be spaced apart from both ends of the body 131 by a predetermined gap and may be connected to the body 131 so as to protrude toward an outer side of the body 131. The hanging portion 132 prevents the movement member 130 from being separated or deviated from the second holder 70. The shape of the hanging portion 132 as shown in FIG. 3 is exemplary, and thus, the present disclosure is not limited thereto.

A width of the penetration portion 133 may not be constant. That is, the width of the penetration portion 133 may vary according to a length direction of the penetration portion 133.

The penetration portion 133 may include a first pipe 134 and a second pipe 135.

A penetration hole 136 through which the suspension rod 110 passes, may be formed in one end of the first pipe 134. The second pipe 135 is connected to the other end of the first pipe 134 and protrudes toward the outer side of the first pipe 134. That is, the second pipe 135 may have a larger width than that of the first pipe 134.

The damper 100 may further include at least one lubricant accommodation portion 180.

The at least one lubricant accommodation portion 180 may be formed at an inner side of the movement member 130 so as to accommodate a lubricant applied to the suspension rod 110. The lubricant prevents the penetration portion 133 of the movement member 130 from being worn out by a frictional force generated between the suspension rod 110 and the movement member 130 that moves integrally with the tub 11 when a shock-absorbing operation of the damper 100 is performed. The lubricant may include grease or any other lubricating substance. Thus, the present disclosure is not limited to the use of grease as the lubricant.

The at least one lubricant accommodation portion 180 may have a shape in which it is recessed toward an outer side of the movement member 130 so as to be far apart or spaced apart from the suspension rod 110 that is movably coupled to the penetration portion 133.

Degrees in which the at least one lubricant accommodation portion 180 are recessed, may be diverse. That is, the amount of space available to accommodate the lubricant in the at least one lubricant accommodation portion may be diverse.

The at least one lubricant accommodation portion 180 may be spaced apart from each other by a predetermined gap.

The at least one lubricant accommodation portion 180 may be formed at an inner side of the movement member 130 so as to be spaced apart from both ends of the movement member 130 and to prevent the lubricant from being discharged to the outside due to vibration of the tub 11. In detail, the at least one lubricant accommodation portion 180 may be formed around the first pipe 134 so as to be spaced apart from the penetration hole 136 downward. As the at least one lubricant accommodation portion 180 is closer to the penetration hole 136, more vibration of the tub 11 may be transmitted to the at least one lubricant accommodation portion 180 through the second holder 70. Thus, as the at least one lubricant accommodation portion 180 is formed closer to the penetration hole 136, breakage or damage possibility of the at least one lubricant accommodation portion 180 increases, and the lubricant may be discharged to the outside. In order to prevent abrasion of the movement member 130 due to lack of the lubricant, the at least one lubricant accommodation portion 180 may be formed around the first pipe 134 so as to be spaced apart from the penetration hole 136 by a predetermined gap in a length direction of the movement member 130.

The at least one lubricant accommodation portion 180 may be formed in the vicinity of the penetration portion 133 corresponding to the hanging portion 132. However, embodiments of the present disclosure are not limited thereto.

The at least one lubricant accommodation portion 180 may be formed long in a length direction of the first pipe 134. The at least one lubricant accommodation portion 180 may be formed around the first pipe 134 so as to be symmetrical with respect to each other. For example, the at least one lubricant accommodation portion 180 may be formed around the first pipe 134 so as to have a “+”-shaped cross-section (see FIG. 5). However, the “+”-shaped cross-section of FIG. 5 is exemplary, and thus, the present disclosure is not limited thereto.

The at least one lubricant accommodation portion 180 may be recessed toward the outer side of the movement member 130 by a degree in which the second pipe 135 protrudes toward the outer side of the first pipe 134.

The damper 100 may further include a frictional member 140 that is provided at an inner side of the movement member 130, so as to face an outer surface of the suspension rod 110.

The frictional member 140 may be provided between the suspension rod 110 and the second pipe 135 so as to be placed under or below the first pipe 134. The frictional member 140 may be coupled to the second pipe 135 and may move integrally with the movement member 130. As the movement member 130 moves integrally with the tub 11, a frictional force is generated between the frictional member 140 and the suspension rod 110 so that a damping force of the damper 100 can be improved.

A width of the frictional member 140 coupled to the second pipe 135 may be the same as that of the first pipe 134. However, embodiments of the present disclosure are not limited thereto.

One end 181 of the at least one lubricant accommodation portion 180 may be opened toward the frictional member 140 in such a way that the lubricant can be transferred to the frictional member 140 and can prevent abrasion of the frictional member 140.

The frictional member 140 may include rubber and/or felt, however, these are exemplary, and thus, the present disclosure is not limited thereto.

The damper 100 may further include a support member 150.

The support member 150 may be coupled to the outer side of the suspension rod 110 so as to prevent the support member 150 from being separated from the suspension rod 110 by the second fixing portion 112.

The damper 100 may further include a shock-absorbing member 160.

The shock-absorbing member 160 may be provided between the movement member 130 and the support member 150 and may make contraction and relaxation motions due to vibration and shock transmitted from the tub 11 so as to absorb the vibration and shock.

The shock-absorbing member 160 may be coupled to the movement member 130 and the support member 150 so as to face the outer surface of the suspension rod 110. One end of the shock-absorbing member 160 coupled to the support member 150 may be fixed to the support member 150, and the other end of the shock-absorbing member 160 coupled to the movement member 130 may move along the suspension rod 110 integrally with the movement member 130.

The shock-absorbing member 160 may be formed of an elastic material so that its length varies according to movement of the movement member 130. For example, the shock-absorbing member 160 may include a spring. However, the use of a spring as the shock-absorbing member 160 is exemplary, and thus, the present disclosure is not limited thereto.

The other end of the shock-absorbing member 160 may be coupled to the hanging portion 132 of the movement member 130. However, embodiments of the present invention are not limited thereto.

The damper 100 may further include a shock-absorbing pipe 170 that is disposed at an outer side of the shock-absorbing member 160 so as to give a frictional force to an outer surface of the shock-absorbing member 160 when contraction and relaxation motions of the shock-absorbing member 160 are made.

A process of damping vibration of the tub 11 by the damper 100 will be described below.

When the washing machine 1 operates, vibration transmitted from the tub 11 is transmitted to the movement member 130 through the second holder 70, and vibration transmitted to the movement member 130 is transmitted to the shock-absorbing member 160 so that vibration can be absorbed by a contraction or relaxation motion of the shock-absorbing member 160. In addition, residual vibration that is not absorbed by the shock-absorbing member 160 is transmitted to not only the second fixing portion 112 and the suspension rod 110 through the support member 150, but also the first fixing portion 111 of the suspension rod 110 and the first holder 60 of the cabinet 10, and thus is finally exhausted. Also, the frictional member 140 disposed at the inner side of the movement member 130 gives a frictional force to the suspension rod 110, and the shock-absorbing pipe 170 disposed at the outer side of the shock-absorbing member 160 gives a frictional force to the shock-absorbing member 160 so that the shock-absorbing effect can be further improved.

When a shock-absorbing operation of the damper 100 is performed, the movement member 130 moves along the suspension rod 110, a frictional force is generated between the movement member 130 and the suspension rod 110. As such, a lubricant is applied between the movement member 130 and the suspension rod 110 so as to prevent the penetration portion 133 of the movement member 130 from being worn out due to the generated frictional force. For the same reason described above, the lubricant may be applied between the frictional member 140 and the suspension rod 110. The lubricant may be accommodated in the at least one lubricant accommodation portion 180 and may be transmitted to at least one of the suspension rod 110 and the frictional member 140.

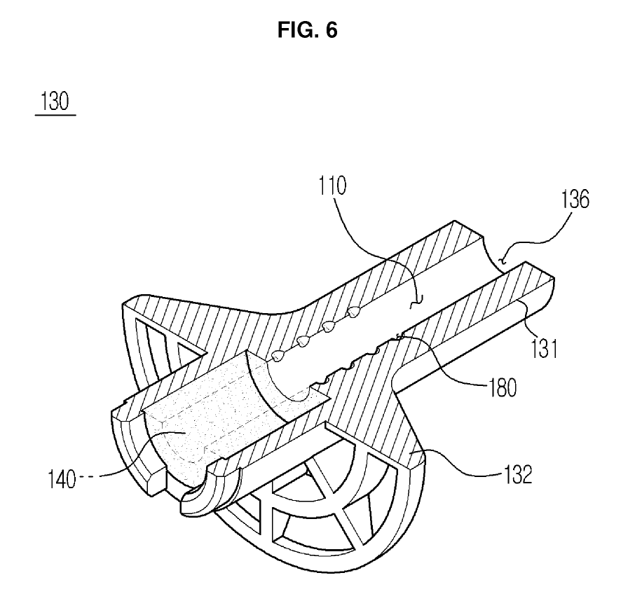

FIG. 6 illustrates a movement member that constitutes a damper of a washing machine according to another example embodiment of the present disclosure. Hereinafter, a redundant description with the description of FIGS. 1 through 5 will be omitted. Also, unillustrated reference numerals refer to FIGS. 1 through 5.

As illustrated in FIG. 6, at least one lubricant accommodation portion 180 may have a shape of a hemisphere that is recessed toward the outer side of the movement member 130.

The at least one lubricant accommodation portion 180 may be spaced apart from each other, and degrees in which the at least one lubricant accommodation portion 180 is recessed toward the outer side of the movement member 130, may be different from each other.

The at least one lubricant accommodation portion 180 having a hemispherical shape may be formed along a circumference of a wall surface of the first pipe 134.

The shape of the at least one lubricant accommodation portion 180 is not limited to the above example and may be modified in various ways.

Lubricant accommodation portions that accommodate a lubricant are formed at an inner side of a movement member so as to be spaced apart from both ends of the movement member by a predetermined gap, thereby preventing the lubricant from being discharged to an outer side of the lubricant accommodation portions due to vibration of a tub.

A sufficient amount of the lubricant is transmitted to a suspension rod and a frictional member so that a constant damping force of a damper can be maintained and durability of the damper can also be improved.

The lubricant is prevented from being discharged to the outer side of the lubricant accommodation portions so that the amount or the frequency of supply of the lubricant can be reduced.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A washing machine comprising a damper provided in a cabinet so as to dampen vibration of a tub,
wherein the damper comprises:
a suspension rod having one end coupled to the cabinet;
a movement member that is coupled to an outer side of the suspension rod so as to move along the suspension rod integrally with the tub;
a support member that is coupled to the other end of the suspension rod; and
a shock-absorbing member disposed between the movement member and the support member, such that the shock-absorbing member varies due to vibration transmitted from the tub, and
wherein at least one lubricant accommodation portion is formed at an inner side of the movement member so as to accommodate a lubricant applied to the suspension rod.

2. The washing machine of claim 1, wherein the at least one lubricant accommodation portion is recessed toward an outer side of the movement member so as to accommodate lubricant between the inner side of the movement member and the suspension rod.

3. The washing machine of claim 1, wherein the at least one lubricant accommodation portion comprises a plurality of lubricant accommodation portions, and the lubricant accommodation portions are spaced apart from each other by a predetermined distance.

4. The washing machine of claim 1, wherein a penetration portion to which the suspension rod is movably coupled and which has different widths, is formed in the movement member.

5. The washing machine of claim 4, wherein the penetration portion comprises:
a first pipe in which the at least one lubricant accommodation portion is formed; and
a second pipe that is connected to the first pipe and protrudes toward an outer side of the first pipe.

6. The washing machine of claim 5, wherein the damper further comprises a frictional member placed between the suspension rod and the second pipe.

7. The washing machine of claim 6, wherein one end of the at least one lubricant accommodation portion is opened toward the frictional member so that the lubricant is capable of being transmitted to the frictional member.

8. The washing machine of claim 5, wherein the at least one lubricant accommodation portion is recessed toward the outer side of the movement member by a degree in which the second pipe protrudes toward the outer side of the first pipe.

9. The washing machine of claim 5, wherein a penetration hole to which the suspension rod is coupled, is formed in one end of the first pipe, and
the at least one lubricant accommodation portion is formed around the first pipe so as to be spaced apart from a through hole by a predetermined gap toward the second pipe.

10. The washing machine of claim 1, wherein the at least one lubricant accommodation portion has a shape of a hemisphere that is recessed toward an outer side of the movement member.

11. The washing machine of claim 1, wherein the at least one lubricant accommodation portion that accommodates the lubricant is formed at an inner side of the movement member so as to be spaced apart from both ends of the movement member by a predetermined gap, thereby preventing the lubricant from being discharged to an outer side of the at least one lubricant accommodation portion due to vibration of the tub.

12. A washing machine comprising a damper provided in a cabinet so as to dampen vibration of a tub,
wherein the damper comprises:
a suspension rod having a top end coupled to the cabinet;
a movement member coupled to an outer side of the suspension rod so as to move along the suspension rod integrally with the tub, and in which at least one lubricant accommodation portion is provided to accommodate a lubricant applied to the suspension rod; and
a shock-absorbing member disposed between the movement member and a bottom end of the suspension rod so as to be relaxed or contracted due to vibration transmitted from the tub,
wherein the at least one lubricant accommodation portion is formed at an inner side of the movement member so as to be spaced apart from both ends of the movement member by a predetermined gap.

13. The washing machine of claim 12, further comprising a penetration portion to which the suspension rod is movably coupled and which has different widths, formed in the movement member.

14. The washing machine of claim 13, further comprising a penetration hole to which the suspension rod is coupled, formed in a top end of the penetration portion, and
wherein the at least one lubricant accommodation portion is placed below the penetration hole so as to be spaced apart from the penetration hole by a predetermined gap.

15. The washing machine of claim 14, wherein the penetration portion comprises:
a first pipe having a top end in which the penetration hole is formed, the at least one lubricant accommodation portion being formed below the penetration hole; and
a second pipe that is connected to a bottom end of the first pipe and protrudes toward an outer side of the first pipe.

16. The washing machine of claim 15, wherein the at least one lubricant accommodation portion is recessed toward an outer side of the first pipe by a degree in which the second pipe protrudes toward the outer side of the first pipe.

17. The washing machine of claim 15, wherein the damper further comprises a frictional member placed between the suspension rod and the second pipe, and
one end of the at least one lubricant accommodation portion is opened toward the frictional member so that the lubricant is capable of being transmitted to the frictional member.

18. A damper comprising:
a suspension rod;
a movement member coupled to an outer side of the suspension rod so as to move along the suspension rod, and in which at least one lubricant accommodation portion is formed to accommodate a lubricant applied to the suspension rod;
a support member fixed to the suspension rod so as to be spaced apart from the movement member by a predetermined gap; and
a shock-absorbing member having one end connected to the movement member so that a length of the shock-absorbing member varies according to movement of the movement member and the other end of the shock-absorbing member connected to the support member,
wherein the at least one lubricant accommodation portion is formed at an inner side of the movement member so as to be spaced apart from both ends of the movement member by a predetermined gap, thereby preventing the lubricant from being discharged to the outside.

19. The damper of claim 18, wherein the at least one lubricant accommodation portion is recessed toward an outer side of the movement member.

20. The damper of claim 19, wherein degrees in which the at least one lubricant accommodation portion is recessed, are diverse.
